(19) United States
(12) Patent Application Publication
(10) Pub. No.: US 2022/0331631 A1
(43) Pub. Date: Oct. 20, 2022

(54) FIRE PROTECTION SPRINKLER WITH A PUSH-IN CONNECTION

(71) Applicant: The Reliable Automatic Sprinkler Co. Inc., Liberty, SC (US)

(72) Inventors: David Deurloo, Liberty, SC (US); Bryan Bassett, Liberty, SC (US); Jeremy Cain, Liberty, SC (US); Paul A. Sasser, Easley, SC (US); Steven D. Wolin, Clemson, SC (US)

(21) Appl. No.: 17/234,090

(22) Filed: Apr. 19, 2021

(51) Int. Cl. A62C 35/68; B05B 15/65

(52) U.S. Cl. CPC A62C 35/68; B05B 15/65

(57) ABSTRACT

A fire protection sprinkler with a push-in connection includes a sprinkler body having an input orifice for receiving fluid and an output orifice for outputting the fluid, the body having a push-in connection at the input end and a base portion. The push-in connection is adapted to be connected to a pipe fitting by insertion and has a plurality of recesses, a first recess having a first gasket, a second recess having a second gasket, and a third recess having a retaining clip. A frangible element is held in place by a set screw and a stopper. The frangible element is designed to fail at a predetermined temperature to release the stopper. A deflector is positioned on the base portion and configured to direct the output fluid toward the output end, upon activation of the sprinkler by failure of the frangible element at the predetermined temperature.

### BACKGROUND OF THE INVENTION

### 1. Field of the Invention

Our invention generally relates to a fire protection sprinkler with a push-in connection.

### 2. Related Art

Fire protection sprinklers conventionally are connected to a conduit to receive pressurized fire-extinguishing fluid, such as water. A typical fire protection sprinkler has a base with a threaded portion for connection to the conduit and an output orifice to output the fluid to provide fire control and/or suppression. The output orifice is sealed by a seal cap, which is held in place by a release mechanism. The release mechanism is designed to release the cap under predetermined conditions, thereby initiating the flow of fire-extinguishing fluid. A typical release mechanism includes a thermally responsive element, e.g., a frangible bulb or a fusible link, and may also include a latching mechanism.

Certain conventional fire protection sprinklers have a pair of arms that extend from the base and meet at a hub portion to form a frame. The hub portion is spaced apart from the output orifice of the base and is aligned with a longitudinal axis thereof. The hub portion may have a set screw configured to apply a pre-tension force to the release mechanism. A deflector may be mounted on the hub, transverse to the output orifice, to provide dispersion of the output fluid.

Fire protection sprinklers may be mounted on a fluid conduit running along a ceiling and may either depend downward from the conduit, which is referred to as a “pendent” configuration, or may extend upward, which is referred to as an “upright” configuration. Alternatively, a sprinkler may be mounted on a wall, a certain distance below the ceiling, which is referred to as a “horizontal sidewall” configuration. Horizontal sidewall sprinklers have an output orifice that is oriented so that the fluid is output horizontally and sprays onto an area to be protected in front of the sprinkler. Pendent sprinklers may be mounted on a “drop”, which is a supply line that extends vertically down from the fluid conduit to supply a single sprinkler. Upright sprinklers may be mounted on a “sprig” or a “sprig-up”, which is a supply line that extends vertically up from the fluid conduit to supply a single sprinkler.

A drop or sprig may be formed by attaching a short section of pipe (referred to as a “nipple”) to a “tee” or a butt-weld branch connection. A tee branch may be formed, for example, by attaching a mechanical tee to the pipe, which has a base that conforms to the pipe and a threaded or a grooved portion that extends from the base. Butt-weld branches may be formed, for example, by welding a fitting to the supply pipe, such as a Weldolet® fitting (Bonney Forge, Mount Union, Pa.), which is a forged steel fitting that conforms to the contour of the supply pipe. A sprinkler may be connected directly to a fitting on the supply pipe or in a threaded connection at the end of the drop or in a threaded connection at the end of the sprig. In the case of a branch connection having a grooved connection, the section of pipe may be anadapter nipple”, which is grooved at one end and a threaded port at the other end for receiving the threaded end of the sprinkler.

One of the disadvantages of the conventional drop or sprig configuration is that it requires the use of a separate pipe section for each sprinkler, which increases the number of components in the system. This also adds to installation time, because it requires the separate steps of connecting the pipe section to the branch and, then, connecting the sprinkler to the pipe section. This configuration also increases the probability of leakage, because it doubles the number of connections between the sprinklers and the conduits (i.e., it requires two connections per sprinkler). Furthermore, conventional threaded sprinkler bodies are not configured to accommodate a grooved connection without an adapter. Moreover, threading the connections together is labor and time intensive.

Sprinklers generally may be categorized as “control mode” or “suppression mode”. Control mode sprinklers are designed to limit the size of a fire by distribution of water, so as to decrease the heat release rate and to pre-wet adjacent combustibles, while controlling ceiling gas temperatures to avoid structural damage. Suppression mode sprinklers are designed to sharply reduce the heat release rate of a fire and to prevent its regrowth by means of direct and sufficient application of water through the fire plume to the burning fuel surface.

The thermal sensitivity of a sprinkler is a measure of the rapidity with which the thermally responsive release mechanism operates as installed in a specific sprinkler or sprinkler assembly. One measure of thermal sensitivity is the response time index (RTI) as measured under standardized test conditions. Sprinklers defined as fast response typically have a thermal element with an RTI of 50 m-s^{1/2} or less. Sprinklers defined as standard response typically have a thermal element with an RTI of 80 m-s^{1/2} or more.

“Control Model Specific Application” sprinklers, as defined in UL 199 (“Standard for Automatic Sprinklers for Fire-Protection Service,” Underwriters' Laboratories, 12^{th} Ed., Apr. 28, 2020), are designed for the protection of stored commodities, as referenced in NFPA 13 (“Standard for the Installation of Sprinkler Systems,” National Fire Protection Association, Inc., 2019 Edition), or particular end use limitations specified for the sprinkler (e.g., specific hazards or construction features). According to Section 3.3.205.4.2 of NFPA 13, a Control Model Specific Application (“CMSA”) sprinkler (for storage use) is, “[a] type of spray sprinkler that is capable of producing characteristic large water droplets and that is listed for its capability to provide fire control in specific high-challenge fire hazards.” Such sprinklers may be used to protect storage of Class I through Class IV commodities, Group A plastic commodities, Rubber Tire, Roll Paper Storage, and other storage, as specified in Chapter 22 of NFPA 13 (see Sections 22.2 through 22.7 inclusive).

Chapter 13 of NFPA 13 specifies requirements for the installation of CMSA sprinklers. Section 13.2.8.2 specifies requirements for installation of CMSA sprinklers near obstructions that may interfere with the sprinkler spray pattern. Section 13.2.8.2.2(1) states that sprinklers are permitted to be attached directly to branch lines less than 4 inches in diameter. Section 12.2.8.2.2(3) states that connection of upright sprinklers to pipe larger than 4 inches must be through a riser-nipple (sprig) that elevates the sprinkler deflector a minimum of 12 inches above the centerline of the pipe. Thus, sprinklers that are designed to be installed without sprig-ups have the advantage of allowing more flexibility in installation.

UL 199 further identifies Early Suppression Fast Response (“ESFR”) sprinklers. Section 5.13 defines an ESFR sprinkler as a, “quick responding sprinkler that automatically discharges water over a specified area to provide early suppression of a fire.” NFPA 13 includes requirements for ESFR sprinklers and their installation in, among other Chapters, Chapters 7, 14, 20, and 23. Section 7.2.2.5 of NFPA 13 specifies that CMSA and ESFR sprinklers shall have a minimum nominal K-factor of 11.2 gpm/psi^{1/2} (160 L/min/bar^{1/2}). Thus, to achieve the minimum K-factor required for a CMSA or ESFR sprinkler the sprinkler attachment method must permit the required minimum K-factor.

Section 8 of UL 199 specifies requirements for inlet threads on sprinklers. Section 8.1 specifies that sprinklers must have inlet threads conforming to ANSI/ASME B1.20.1, “Standard for Pipe Threads, General Purpose (Inch)”. However, Exception 4 to Section 8.1 specifies that sprinkler inlets intended for attachment by means other than threads may be used when the sprinkler is provided with nominal K-factor markings and where the sprinkler is, “intended to be attached in a manner that does not involve welding and that permits sprinkler removal from sprinkler piping without the use of special tools or torch cutting equipment.” No further guidance is provided in UL 199 on the types of attachment methods that may be used.

Chapter 7 of NFPA specifies requirements for sprinkler system components and hardware. Section 7.2 specifies requirements for sprinklers. Section 7.2.2.1 references Table 7.2.2.1 for sprinkler K-factor, relative discharge, and marking requirements. Table 7.2.2.1 specifies sprinkler K-factors ranging from 1.4 gpm/psi^{1/2} (20 L/min/bar^{1/2}) to 28.0 gpm/psi^{1/2} (400 L/min/bar^{1/2}) with corresponding thread types ranging from ½ inch (15 mm) NPT to 1 inch (25 mm) NPT. Section 7.2.2.2 specifies that listed sprinklers with pipe threads other than those shown in Table 7.2.2.1 are permitted. NFPA 13, however, does not contemplate sprinklers with attachment methods other than threads.

FIG. 1 is an elevational view, partly in section, showing a conventional upright fire protection sprinkler 100 having a body 101 with an extended portion 105, mounted on a supply pipe 103 using a conventional threaded branch connection 106. The supply pipe 103 has a nominal inner diameter (ID) of, for example, 2 inches or 3 inches and an outer diameter (OD) of 2.375 inches or 3.5 inches, respectively. The branch connection in this example has a height of 1.25 inches and a diameter of 1.90 inches, and it may be used on either 2 inch or 3 inch supply pipes. A dimension D2 may be defined between the underside of the deflector 160 and the top edge 170 of the body 101. The top edge 170 of the sprinkler body 101 has a diameter (W), and the hub 140 has a radius X. A height H may be defined between the top of the deflector 160 and a center line of the supply pipe 103.

For comparison purposes, a similar set of dimensions may be defined for a conventional sprinkler positioned on a supply pipe. In such a case, the diameter W is defined by the width of the wrench boss (i.e., the distance between the flat edges of the wrench boss), which forms the top edge of the conventional sprinkler. The desired height H may be achieved by using a sprig-up, which may include various configurations of pipe sections and adapters.

A shadow diameter S may be defined, which corresponds to the diameter of the conical-shaped, shadowed region at a particular distance beneath the sprinkler 100. To account for shadowing caused by the supply pipe 103 (as opposed to the structure of the sprinkler 100), the shadow diameter S is considered to have a baseline value corresponding to the diameter (OD) of the supply pipe 103. The baseline value may change, by an amount defined as ΔS, depending upon the particular dimensions of the sprinkler, as discussed below. The resulting composite shadow diameter (S′), which is based on the dimensions of the supply pipe and the sprinkler, is given by the expression: S′=S+ΔS. The value of S′ may be less than, equal to, or greater than the baseline shadow diameter (S).

Enhanced protection extended coverage (EPEC) sprinklers are designed to meet the requirements of the Loss Prevention Certification Board (LPCB), which provides certification for sprinkler systems in the U.K. EPEC sprinklers are designed to provide protection for storage applications meeting Ordinary Hazard Group III criteria, in accordance with Technical Bulletin TB222. The relevant standards allow coverage of an area of 17.6 m², which corresponds to a sprinkler spacing of 4.2 m (about 13.8 ft). By contrast, standard (non-extended coverage) sprinklers provide a coverage area of 12 m², which corresponds to a spacing of 3.5 m (about 11.5 ft).

FIG. 2 shows a conventional enhanced protection extended coverage (EPEC) pendent fire protection sprinkler 200. The sprinkler 200 has a body 210 defining an axial fluid passage through the body 210. The top of the body 210 has a threaded portion 220 on its outer surface to allow the sprinkler 200 to be connected to a conduit (not shown) to provide pressurized fire-extinguishing fluid, such as water, to an input end 225 of the fluid passage. The fluid passage has an output orifice 230 at the opposite end that is sealed by a seal cap 235. The input end 225 may have a diameter of, for example, ¾ inch NPT (national pipe thread). The sprinkler 200 may have a K-factor of, for example, 8.0 gpm/psi^{1/2}, which is defined by K=Q/\sqrt{p}, where Q is the flow rate in gallons per minute and p is the residual pressure at the inlet of the sprinkler in pounds per square inch (which corresponds to a metric K-factor of 115 L/min/bar^{1/2}). Larger K-factors, for example, 11.2 gpm/psi^{1/2} (160 L/min/bar^{1/2}) or 14 gpm/psi^{1/2} (200 L/min/bar^{1/2}) or 16.8 gpm/psi^{1/2} (240 L/min/bar^{1/2}) or 22.4 gpm/psi^{1/2} (320 L/min/bar^{1/2}) or 25.2 gpm/psi^{1/2} (360 L/min/bar^{1/2}) or 28.0 gpm/psi^{1/2} (400 L/min/bar^{1/2}), are also possible.

Two frame arms 240 extend from the lower portion of the body 210 and meet at a hub 245 positioned below and in axial alignment with the output orifice 230. A deflector 300 is positioned on the hub 245 so as to be impinged by the output fluid upon activation of the sprinkler 200. As further discussed below, the deflector 300 in this particular embodiment is a circular disk that is centered on and orthogonal to the axis of the fluid passage. The disk has a number of slots of varying length and orientation arrayed around its periphery.

A release mechanism having a thermally responsive element, e.g., a frangible bulb 250, is positioned between the hub 245 and the seal cap 235 to hold the seal cap 235 in place over the output orifice 230. As shown in FIG. 2, the bulb 250 is positioned between the seal cap 235 and a set screw 255. The bulb 250 is designed to burst at the predetermined temperature, which, in turn, releases the seal cap 235 and allows the fluid to be output from the orifice 230. Of course, other types of release mechanisms may be used, including, but not limited to, a fusible link assembly or a sensor, a strut, and a lever assembly.

FIGS. 3 to 5 show an embodiment of the deflector 300, which, as noted above, is a circular disk having a number of slots of varying length and orientation arrayed around its periphery. The deflector 300 is formed of metal, such as, for example, phosphor bronze, and has a radius of about 0.8 inch and a thickness of about 0.06 inch. In alternative embodiments, the radius may be between about 0.5 inch and about 1.1 inches, preferably, about 0.7 inch to 0.9 inch. The deflector is formed by stamping a thin piece of metal to form a flat, circular blank (not shown) with slots. The blank may be about 0.02 inch larger in diameter than the finished deflector, due to the bending of the edges, as discussed below.

The edges of the blank are curved or bent in a further process, so that the outer edges 310 (see FIG. 4) of the deflector 300 extend away from the outlet orifice 330. For example, as shown in FIG. 4, the edges 310 of the deflector 300 may be bent to form an angle of about 14° with respect to the plane of the deflector 300 (this angle may be between about 5° and about 30°, preferably, about 10° to about 20°, in alternative embodiments), such that the deflector 300 has a planar central portion 320 with a radius of about 0.65 inch. The central portion 320 may have a radius of between about 0.4 inch and about 0.9 inch, preferably, about 0.6 inch to 0.7 inch. Alternatively, the edges may be left flat.

The positions of the slots may be described in terms of the approximate angle between each slot and section line 4-4, which extends horizontally though the planar view of the deflector 300 shown in FIG. 3. In the exemplary embodiment, a pair of “aligned slots” 325 is cut out along section line 4-4, and extends to the outer edge 310 of the deflector 300. The aligned slots 325 are aligned with the plane of the frame arms 340. The aligned slots 325 have a radial length of about 0.35 inch (which is about 44% of the deflector radius). In alternative embodiments, the length of the aligned slots 325 may be between about 0.2 inch and about 0.6 inch, preferably, about 0.3 inch to about 0.4 inch.

The width of the aligned slots 325 is about 0.08 inch, which, in alternative embodiments, may vary about ±20%, preferably, about ±15%. The width of the aligned slots 325 is designed to provide a desired amount of additional water to the areas under the frame arms 340, i.e., the area almost directly below the sprinkler 200. This helps to counteract the “shadowing effect,” which is the tendency of the frame arms 340, depending upon their width, to block water output to the area below the frame arms 340. By contrast, extending the length of the aligned slots 325 towards the center of the deflector 300 might result in a structurally weakened deflector, due to the proximity of the inner end of the aligned slots 325 to the adjacent angled slots 345.

A pair of “perpendicular slots” 335 is perpendicular to section line 4-4. The perpendicular slots 335 also are perpendicular to the plane of the frame arms 340. The perpendicular slots 335 have a radial length of about 0.46 inch (which is about 58% of the deflector radius) and a width of about 0.06 inch. In alternative embodiments, the length of the perpendicular slots 335 may be between about 0.3 inch and about 0.7 inch, preferably, about 0.4 inch to about 0.5 inch. The width of the perpendicular slots may be about 0.06 inch, which, in alternative embodiments, may vary about 20%, preferably, about ±15%.

Four “corner slots” 340 form an angle of about 50° with section line 4-4, each having a radial length of about 0.56 inch (about 70% of the deflector radius) and a width of about 0.70 inch. In alternative embodiments, the angle of the corner slots 340 may be between about 40° and about 60°, and the length of the corner slots 340 may be about 0.4 inch to about 0.7 inch, preferably, about 0.5 inch to about 0.6 inch. The width of the corner slots 340 may be about 0.06 inch, which, in alternative embodiments, may vary about ±20%, preferably, about 15%.

Four angled slots 345 (“the first angled slots”) are positioned on both sides of the aligned slots 325 and are oriented to form an angle of about 30° with respect to the aligned slots 325. In alternative embodiments, the angle may be about 15° to about 45°, preferably, about 20° to about 40°. The radial length of the first angled slots 345 (with respect to the center of the deflector) is about 0.4 inch (about 50% of the deflector radius), and these angled slots 345 have a width of about 0.70 inch. The inner ends of the first angled slots 345 are positioned at a radius of about 0.4 inch. In alternative embodiments, the length of these slots 345 may be about 0.2 inch to about 0.6 inch, preferably, about 0.3 inch to about 0.5 inch. The width may vary about ±20%, preferably, about ±15%.

An additional four angled slots 350 (“the second angled slots”) are positioned on either side of the perpendicular slots 335 and are oriented to form an angle of about 20° with respect to the perpendicular slots 335. In alternative embodiments, this angle may be between about 5° and about 35°, preferably, about 10° to about 30°. The radial length of the second angled slots 350 (with respect to the center of the deflector 300) is about 0.2 inch (about 25% of the deflector radius), and these slots 350 have a width of about 0.09 inch. The inner ends of the second angled slots 350 are positioned at a radius of about 0.6 inch. In alternative embodiments, the length of these slots 350 may be about 0.2 inch to about 0.4 inch, preferably, about 0.2 inch to about 0.25 inch. The width may vary about ±20%, preferably, about ±15%.

The slots discussed above have rounded inner ends with a radius equal to about half of the slot width, but other geometries may also be used for the inner ends. Of course, the deflector 300 may have other slots in addition to those described above.

FIG. 5 is a perspective view of the deflector 300 showing the surface facing toward the outlet orifice. Each of the elements of deflector 300 has been discussed above in connection with FIGS. 3 and 4.

In accordance with Technical Bulletin TB222, EPEC sprinklers must be tested through measurements of actual delivered density and through commodity fire tests, in which an array of sprinklers is tested in operation over predetermined configurations of commodities. The water flow from the sprinklers must be controlled by the deflector to achieve an output pattern that meets the required actual delivered density specified for the sprinkler. Representative sample sprinklers are installed at a specified spacing for each fire test, which is either 4.0 m or 4.2 m for K-8.0 (metric K-factor 115). The required density is either 6.0 mm/min (for Ordinary Hazard Group III/10) or 6.5 mm/min (for Ordinary Hazard Group III/12.5) over a design area of 160 m², which corresponds to an array of ten sprinklers, each covering 16 m².

To maintain the proper density of water output over the specified area, the sprinkler must have a spray pattern that is approximately square. To achieve such a pattern, the corner slots are designed to be somewhat longer than the aligned slots and the perpendicular slots, in order to project more water toward the corners of the spray pattern. Likewise, the first and second sets of angled slots are angled toward the corner of the output pattern, which further tends to create a square pattern. In addition, directing the output spray toward the corner of the spray pattern lessens the amount of water output toward adjacent sprinklers. This helps to prevent “cold soldering,” which is a condition in which water is output by a sprinkler directly onto an adjacent sprinkler, thereby lowering the temperature of the adjacent sprinkler and preventing that adjacent sprinkler from properly activating or operating.

For more than one hundred years, sprinklers have been manufactured with threads for connection to pipe, as noted above. Sprinklers with threads are typically connected to pipe using a welded, threaded outlet, or a mechanically connected threaded outlet. A welded threaded outlet is typically connected to pipe by creating a hole in the pipe, and then welding the welded, threaded outlet around the hole in the pipe. A mechanically connected threaded outlet is typically connected to pipe by cutting a hole in the pipe, and, then, mechanically attaching the mechanically connected threaded outlet to the pipe around the hole, often using a clamp around the circumference of the pipe.

Thus, fire sprinklers have traditionally been connected to pipe using a threaded connection. Most often, external threads on the sprinkler engage internal threads of a pipe outlet. The threaded connection both retains the sprinkler to the outlet and creates a water-tight seal between the sprinkler and the outlet. Threads used to connect sprinklers to pipe are often tapered and are often manufactured to conform to ANSI B1.20.1, “Pipe Threads, General Purpose (Inch)” or ISO 7-1, “Pipe Threads Where Pressure-tight Joints are Made on the Threads”. Tapered sprinkler threads typically require a thread sealant, such as polytetrafluoroethylene (PTFE) tape or pipe dope, to create a water-tight seal with the outlet. The sprinkler threads are thereby connected to the outlet using the thread sealant, often, the polytetrafluoroethylene (PTFE) tape, applied to the sprinkler threads, then, tightening the sprinkler into the outlet using a wrench. Sprinklers typically have threads of 0.5 inch, 0.75 inch, or 1 inch nominal size, although sprinklers with 1.25 inch nominal threads are available. As the thread size increases, the amount of torque needed to install the sprinkler, while limiting leaks, also increases. This makes the installation more time and labor intensive. Thus, desirable is a less time and labor-intensive method of connecting sprinklers to pipe.

In addition, fire sprinklers are often required to protect storage buildings. The typical height of storage buildings has increased over the past several decades, often requiring larger sprinklers that can discharge more water to control or to suppress fires in the taller storage area. These larger sprinklers require larger pipe connections that require substantial torque to install. This can result in fatigue and inefficiency among sprinkler installers.

Alternatively, pipe outlets may have an elastomeric gasket to create a water-tight seal with a sprinkler. Pipe outlets are often welded to the pipe, however, which precludes the use of elastomeric gaskets installed in the pipe outlet prior to welding that could be damaged by high heat from the welding process. For this reason, pipe outlets with elastomeric seals are typically limited to pipe outlets for plastic pipe that are connected to the pipe with a solvent cement.

Sprinklers are also manufactured with an external groove for connection to an outlet having a groove in its outer perimeter using a grooved coupling. The grooved coupling typically comprises two housings that are connected together with one or more bolts or screws and a sealing gasket. When connected together, the two housings span between and connect the groove in the sprinkler with the groove in the outer perimeter of the outlet. The sealing gasket seals against both the outer circumference of the sprinkler and the outer circumference of the outlet, providing a water-tight conduit between the sprinkler and the outlet. The grooved coupling connects the sprinkler to the outlet so that the end of the sprinkler remains outside of the outlet. This causes the sprinkler to extend farther away from the pipe than an otherwise identical sprinkler inserted partially into the outlet (such as one with threads). Moving the sprinkler farther from the pipe requires more space for installation, creates a more difficult arrangement in order to support the sprinkler during seismic events, and may cause the sprinkler to be located farther from a ceiling. This may even delay activation, which, of course, is disadvantageous.

Generally speaking, so called quick connector assemblies are also known in the art. For example, U.S. Pat. No. 9,851,035 discusses such a quick connector assembly that includes a housing with an open bore that extends along an axis from an open first end for receiving a cross-linked polyethylene (PEX) tube to an open second end for receiving copper or chlorinated polyvinyl chloride (CPVC) pipe. The housing presents an inner surface that defines the open bore and an outer surface. Between the first and second ends, the housing serially extends through a first end section, a first intermediate section, a second intermediate section, and a second end section. The outer surface of the first end section is formed according to ASTM F-1960 standards to establish a fluid connection with the PEX tube through a standard expansion connection with a PEX expansion ring. The first end section could, however, be configured for attachment with the PEX tube through any suitable style of connection including, for example, shark bite connections, compression connections, crimping connections, clamping connections, or pressing connections. The housing is preferably made as one integral piece of a polymeric material and is preferably formed through an injection molding process. The housing also may be made of any suitable materials and through suitable forming processes.

Another so called quick connect fitting is discussed in U.S. Pat No. 9,650,768. This quick connect fitting includes a housing attached to a quick connect portion of a molded base. A retention ring attached to an adapter is held in place in the quick connect fitting by a housing and a retention clip. The quick-connect fitting also includes a first O-ring, a back-up ring, and a second O-ring to seal the connection. Another illustrative quick connect fitting is available from BrassCraft Mfg. Co, Novi, Mich. Parts of the quick connect fitting vary depending on the connector system for use therewith. Exemplary connector systems may include, but are not limited to, SureConnect™ and NGS (available from BrassCraft Mfg Co, Novi, Mich.), Push-to-Lock™ (available from Rayconnect Inc, Rochester Hills, Mich.), the Shark Bite Connection System™ (available from Reliance Worldwide Corporation, Birmingham, Ala.), or JG Speedfit™ (available from John Guest USA, Inc, Fairfield, N.J.).

Such quick connector assemblies and quick connect fittings have drawbacks, however, in that they are typically “one and done.” In other words, once connected, they may not be easily unconnected. If unconnected, the connections are damaged. This is not practical for use with fire protection sprinklers that may need to be removed for various reasons, such as inspection, testing, or replacement.

Accordingly, a need has arisen to provide a fire protection sprinkler with a push-in connection that overcomes the drawbacks associated with conventional devices, as noted above, while yet still providing for the requisite spray patterns and/or outputs needed in the industry for fire suppression.

### SUMMARY OF THE INVENTION

In view of the problems discussed above, our invention is directed to a fire protection sprinkler with a push-in connection that is a mechanism for connecting and sealing a fire protection sprinkler to pipe without the use of threads or thread sealant. The mechanism thereby allows a sprinkler to be manually connected to a pipe outlet without the use of a wrench. The mechanism also avoids the use of thread seals by providing the seal(s) as part of the sprinkler. In addition, the mechanism allows for the removal of the sprinkler from the pipe outlet for various reasons, such as inspection, testing, or replacement.

The mechanism comprises one or more seals located in one or more grooves on the sprinkler. Preferably, more than one seal is used to provide redundancy and to reduce (or to eliminate) the potential for leakage. An advantage of our mechanism is that all seals are located on the sprinkler, not on the pipe outlet. This allows the pipe outlet, prior to installation of the sprinkler, to be attached to the pipe using a welded connection, without concern for the high temperatures from the welding process damaging the seal.

Our mechanism further comprises a clip used to retain the sprinkler in the pipe outlet. The clip is retained within a groove in the sprinkler. The clip temporarily deforms while the sprinkler is inserted into the pipe outlet and, when the sprinkler is fully inserted, is then retained by both the groove in the sprinkler and a corresponding groove in the pipe outlet. The groove in the sprinkler includes a retaining surface designed to press the clip into the groove in the pipe outlet when elevated pressure in the pipe presses the sprinkler in a direction away from the pipe outlet. The force from the retaining surface against the clip when water pressure is applied to the inlet further prevents the sprinkler from being removed from the pipe outlet when there is pressurized fluid in the pipe.

The clip has two ends that are not retained within the groove in the sprinkler or the groove in the pipe outlet. When the inlet of the sprinkler is not pressurized, the two ends of the clip may be used to reduce the radius of the clip so that the clip can be retained within the groove in the sprinkler, but not the groove in the pipe outlet, thereby allowing the sprinkler to be removed from the pipe outlet.

The sprinkler may be installed in a pipe outlet by merely pressing the sprinkler into the pipe outlet. Pressing the sprinkler into the pipe outlet will cause the clip to retract into the groove in the sprinkler to allow the sprinkler to be inserted into the pipe outlet. When the sprinkler is inserted into the pipe outlet so that the groove in the sprinkler is adjacent to the groove in the pipe outlet, the clip will elastically expand into the groove in the pipe outlet, releasably retaining the sprinkler in the pipe outlet.

These and other features of our invention will be described with reference to the drawings, described below.

### BRIEF DESCRIPTION OF THE DRAWINGS

FIG. 1 is an elevational view, partly in section, of a conventional upright fire protection sprinkler mounted on a supply conduit (shown in cross section) with a threaded connection.

FIG. 2 is an elevational view of a conventional enhanced protection extended coverage pendent sprinkler having threads for connection to a supply conduit.

FIG. 3 is a plan view of a deflector showing a surface facing away from an outlet orifice in the sprinkler shown in FIG. 2.

FIG. 4 is a sectional, elevational view of the deflector shown in FIG. 3, taken along line 4-4 in FIG. 3, in the plane of the frame arms.

FIG. 5 is a perspective view of the deflector shown in FIGS. 3 and 4 showing the surface facing toward the outlet orifice.

FIG. 6 is a perspective view showing a fire protection sprinkler with a push-in connection of our invention.

FIG. 7A is an elevational view showing the fire protection sprinkler with a push-in connection of our invention in an assembled (i.e., installed) state.

FIG. 7B is an elevational view showing the fire protection sprinkler with a push-in connection of our invention prior to being installed.

FIG. 8 is an exploded view showing a fire protection sprinkler with a push-in connection of our invention.

FIG. 9 is an elevational, cross-sectional view taken along line 9-9 shown in FIG. 7A of a fire protection sprinkler with a push-in connection of our invention in an assembled (i.e., installed) state.

FIG. 10 is a partial, elevational, cross-sectional view taken along line 10-10 shown in FIG. 7A of a fire protection sprinkler with a push-in connection of our invention.

FIG. 11 shows a perspective view of an O-ring seal for use with a fire protection sprinkler with a push-in connection of our invention.

FIG. 12 is a plan view of a retainer clip for use with a fire protection sprinkler with a push-in connection of our invention.

FIG. 13 is an elevational view of a retainer clip that may be used with a fire protection sprinkler with a push-in connection of our invention.

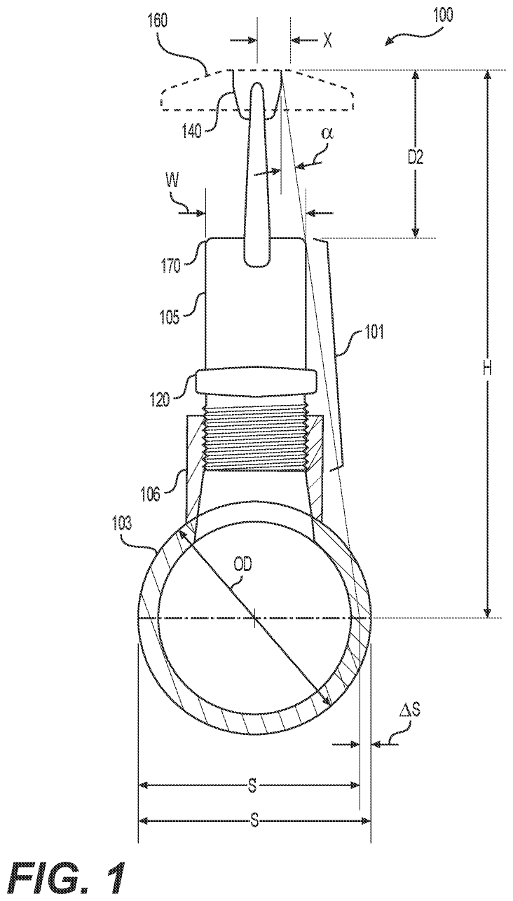

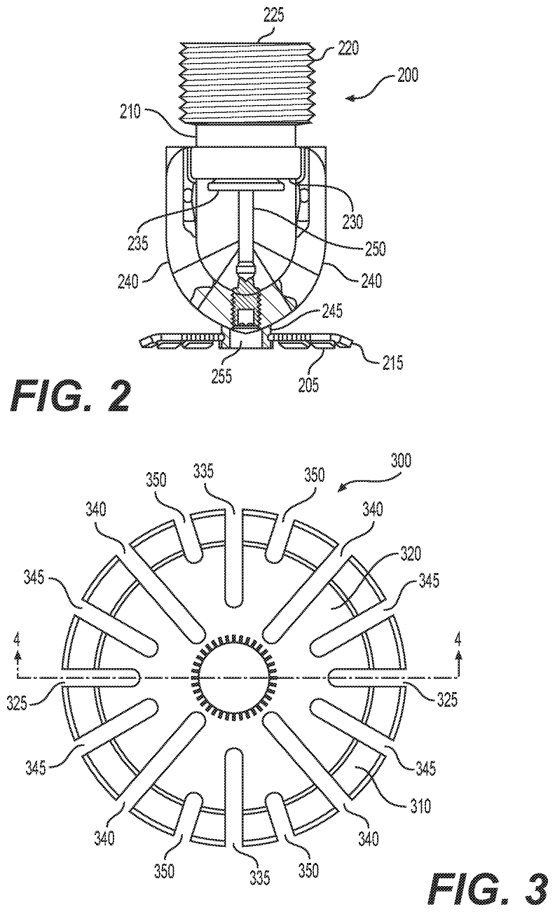

### DESCRIPTION OF THE EMBODIMENTS

Our invention relates to a fire protection sprinkler with a push-in connection that includes a sprinkler body having an input orifice at an input end of the sprinkler for receiving fluid and an output orifice at an output end for outputting the fluid, the body having a push-in connection portion at the input end and an extended portion extending between the push-in connection portion and the output end, the push-in connection portion being adapted to be connected to a pipe fitting by insertion and having a plurality of recesses, a first recess having a first gasket therein, a second recess having a second gasket therein, and a third recess having a retaining clip therein, a pair of frame arms extending from the input end and meeting at a base portion positioned in axial alignment with the output orifice, wherein the frame arms are integrally formed with the body, a frangible element held in place on its lower end by a set screw and on its upper end by a stopper, the set screw being attached to the base portion, the frangible element being designed to fail at a predetermined temperature in order to release the stopper, and a deflector positioned on the base portion and configured to direct the fluid output from the output orifice substantially in a direction toward the output end, upon activation of the sprinkler by failure of the frangible element at the predetermined temperature.

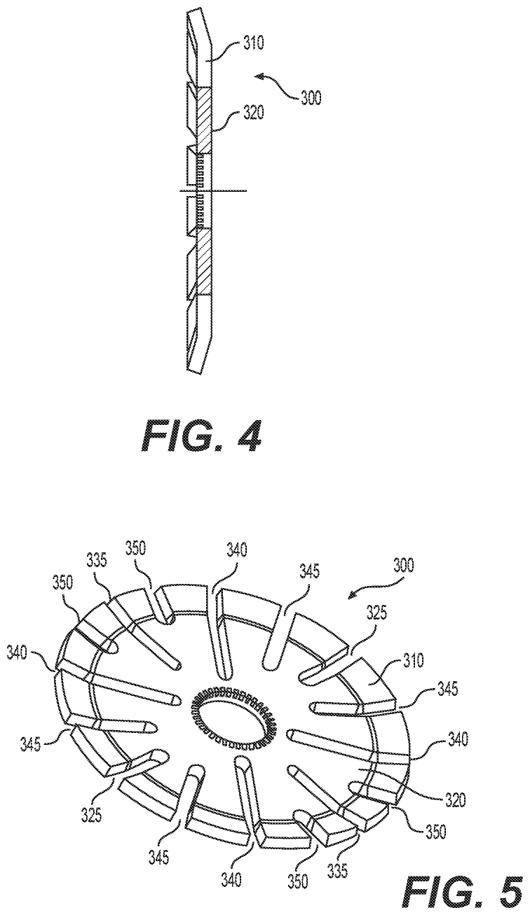

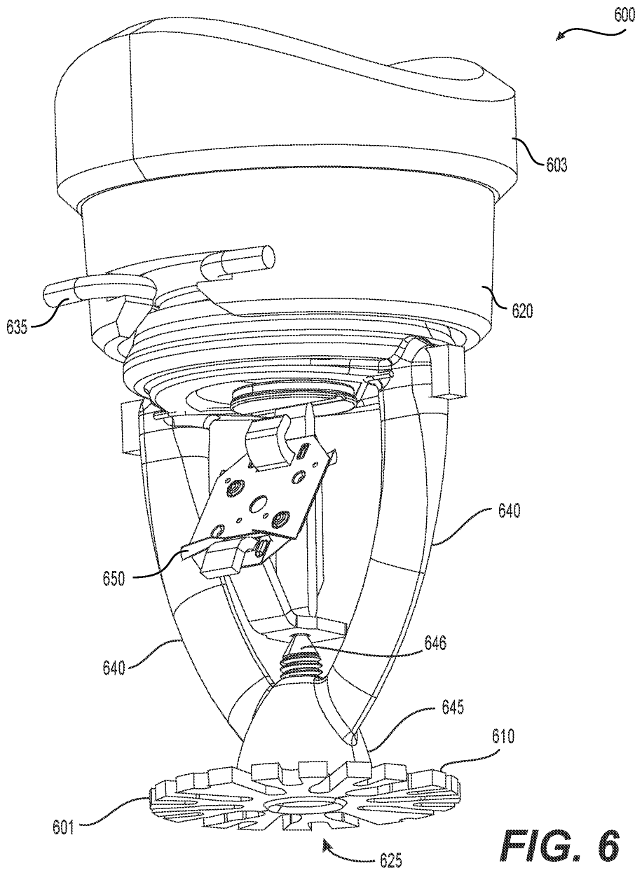

FIG. 6 is a perspective view showing a fire protection sprinkler with a push-in connection 600 of our invention. FIG. 6 shows housing 620 of our sprinkler with a push-in connection 600 inserted into (i.e., installed in) pipe outlet 603. The sprinkler with a push-in connection 600 is held in place by retaining clip 635, as will be discussed in more detail below. The sprinkler includes frame arms 640 extending to base portion 645. The sprinkler also includes a frangible element 650 that is held in place by a set screw 646. The sprinkler further includes a deflector 625 extending from the base portion 645. Deflector 625 includes upper surface 610 and peripheral edges 601. The deflector 625 may be one such as discussed above with respect to FIGS. 3 to 5. As noted above with reference to FIGS. 3 to 5, deflector 625 can be a circular disk having a number of slots of varying length and orientation arrayed around its periphery. The deflector 625 is formed of metal, such as, for example, phosphor bronze.

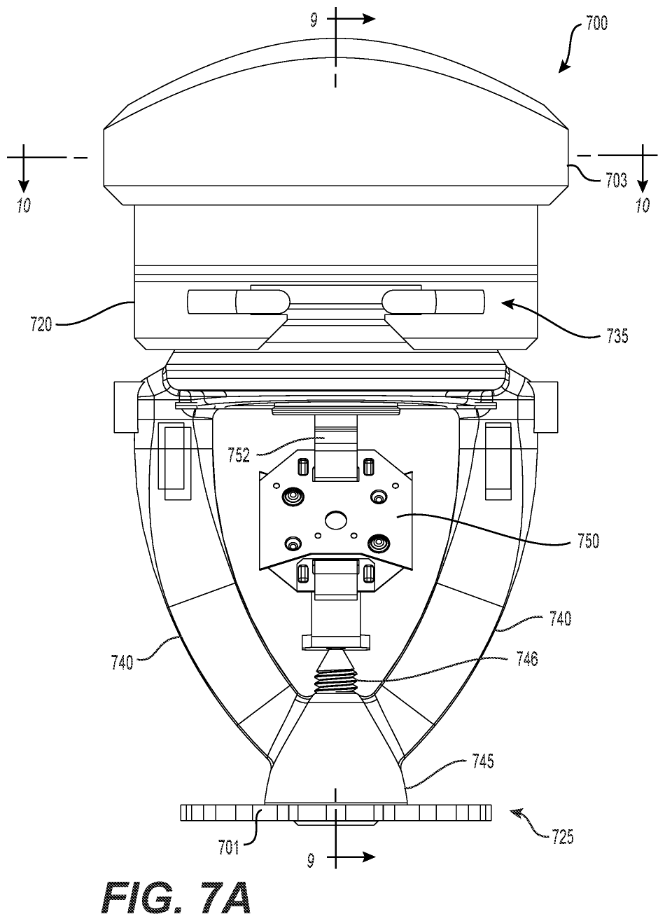

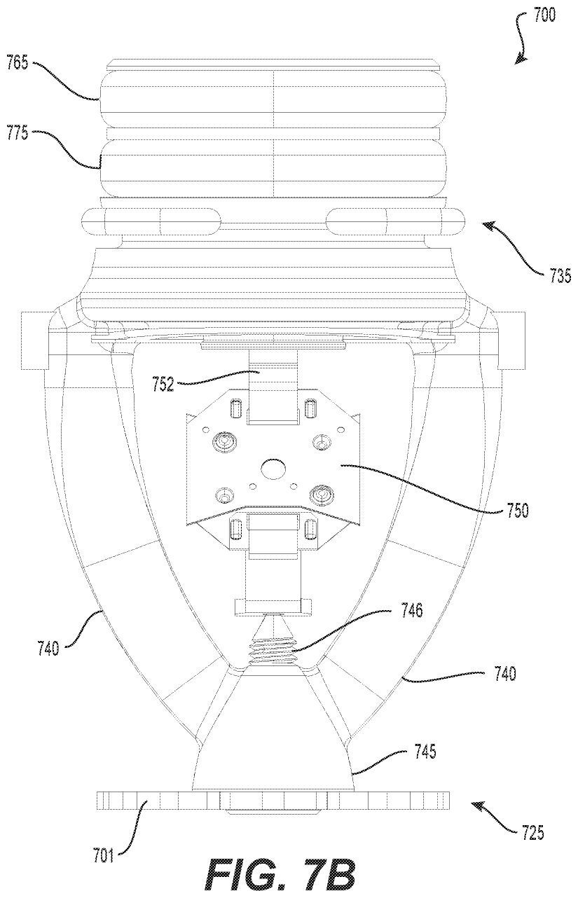

FIG. 7A is an elevational view showing the fire protection sprinkler with a push-in connection 700 of our invention in an assembled (i.e., installed) state. In more detail, FIG. 7A shows housing 720 of our sprinkler with a push-in connection 700 inserted into (i.e., installed in) pipe outlet 703. The sprinkler with a push-in connection 700 is held in place by retaining clip 735, as will be discussed in more detail below. The sprinkler includes frame arms 740 extending to base portion 745. The sprinkler also includes a frangible element 750 that is held in place on its lower end by a set screw 746 and on its upper end by connector 752. The sprinkler also includes a deflector 725 extending from the base portion 745. Deflector 725 includes peripheral edges 701. The deflector may be one such as discussed above with respect to FIGS. 3 to 5. As noted above with reference to FIGS. 3 to 5, deflector 725 can be a circular disk having a number of slots of varying length and orientation arrayed around its periphery. The deflector 725 is formed of metal, such as, for example, phosphor bronze.

FIG. 7B is an elevational view showing the fire protection sprinkler with a push-in connection 700 of our invention prior to being inserted into (i.e., installed in) a pipe outlet. Notably, FIG. 7B shows a first gasket or O-ring seal 765 and a second gasket or O-ring seal 775 mounted in corresponding recesses as will be discussed in more detail below. As noted above, the sprinkler with a push-in connection 700 is held in place by retaining clip 735, as also will be discussed in more detail below. The sprinkler includes frame arms 740 extending to base portion 745. The sprinkler also includes a frangible element 750 that is held in place on its lower end by a set screw 746 and on its upper end by connector 752. The sprinkler further includes a deflector 725 extending from the base portion 745. Deflector 725 includes peripheral edges 701. The deflector may be one such as discussed above with respect to FIGS. 3 to 5. As noted above with reference to FIGS. 3 to 5, deflector 725 can be a circular disk having a number of slots of varying length and orientation arrayed around its periphery. The deflector 725 is formed of metal, such as, for example, phosphor bronze.

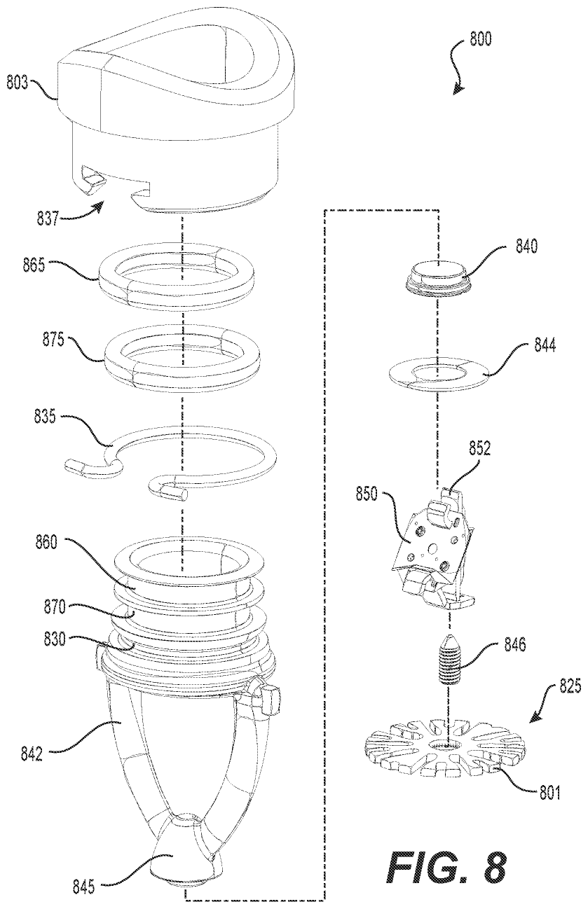

FIG. 8 is an exploded view showing a fire protection sprinkler with a push-in connection 800 of our invention prior to being inserted into (i.e., installed in) pipe outlet 803. Pipe outlet 803 has a notch 837 into which the retaining clip 835 will be engaged. FIG. 8 shows first gasket or O-ring seal 865 and second gasket or O-ring seal 875 to be mounted in corresponding recesses 860 and 870. Similarly, retaining clip 835 will be mounted in corresponding recess 830 as will be discussed in more detail below. The sprinkler includes frame arms 842 extending to base portion 845. The sprinkler also includes a frangible element 850 that is held in place on its lower end by a set screw 846 and on its upper end by connector 852. The connector 852 connects with a sealing cap or stopper 840 having a washer or other disk spacer 844 in between. The sprinkler also includes a deflector 825 that will extend from the base portion 845. Deflector 825 includes peripheral edges 801. The deflector may be one such as discussed above with respect to FIGS. 3 to 5. As noted above with reference to FIGS. 3 to 5, deflector 825 can be a circular disk having a number of slots of varying length and orientation arrayed around its periphery. The deflector 825 is formed of metal, such as, for example, phosphor bronze.

Accordingly, the fire protection sprinkler with a push-in connection 800 of our invention comprises one or more gaskets or O-ring seals 865 and 875 located in one or more corresponding recesses 860 and 870. Preferably, more than one gasket or O-ring seal is used to provide redundancy and to reduce (or to eliminate) the potential for leakage. An advantage of our mechanism is that all seals are located on the sprinkler, not on the pipe outlet. This allows the pipe outlet (not shown in FIG. 8), prior to installation of the fire protection sprinkler with a push-in connection 800, to be attached to the pipe using a welded connection, without concern for the high temperatures from the welding process damaging the seal.

The fire protection sprinkler with a push-in connection 800 of our invention further comprises retaining clip 835 used to retain the sprinkler in the pipe outlet. The retaining clip 835 is retained within the groove 837 in the fire protection sprinkler with a push-in connection 800 of our invention. The retaining clip 835 temporarily deforms while the fire protection sprinkler with a push-in connection 800 is inserted into the pipe outlet and, when the fire protection sprinkler with a push-in connection 800 is fully inserted, is then retained by both the groove 837 in the fire protection sprinkler with a push-in connection 800 and a corresponding groove in the pipe outlet. The groove 837 in the sprinkler fire protection sprinkler with a push-in connection 800 includes a retaining surface designed to press the retaining clip 835 into the groove in the pipe outlet when elevated pressure in the pipe presses the sprinkler fire protection sprinkler with a push-in connection 800 in a direction away from the pipe outlet. The force from the retaining surface against the clip when water pressure is applied to the inlet further prevents the fire protection sprinkler with a push-in connection 800 from being removed from the pipe outlet when there is pressurized fluid in the pipe.

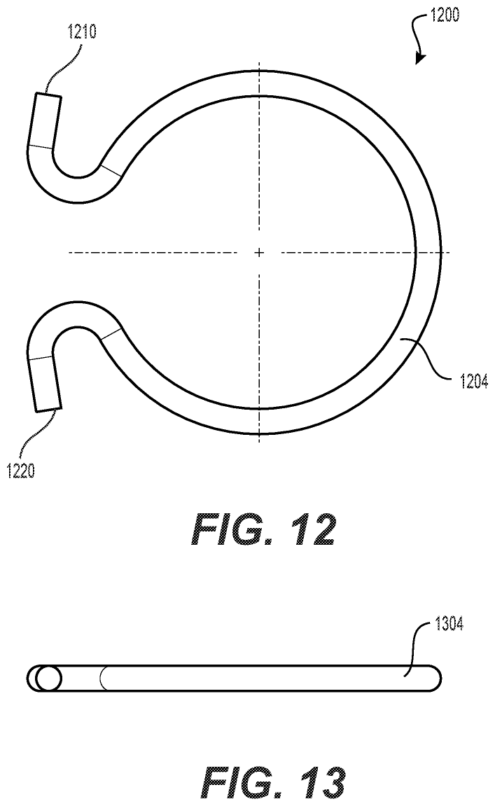

The retaining clip 835 has two ends (shown in FIG. 8, but not enumerated, but see elements 1210 and 1220 shown in FIG. 12) that are not retained within the groove 837 in the fire protection sprinkler with a push-in connection 800 or the corresponding groove in the pipe outlet. When the inlet of the fire protection sprinkler with a push-in connection 800 is not pressurized, the two ends of the retaining clip 835 may be used to reduce the radius of the retaining clip 835 so that the retaining clip 835 can be retained within the groove 837 in the fire protection sprinkler with a push-in connection 800, but not the corresponding groove in the pipe outlet, thereby allowing the fire protection sprinkler with a push-in connection 800 to be removed from the pipe outlet for desired reasons, such as inspection, testing, or replacement.

The fire protection sprinkler with a push-in connection 800 thereby may be installed in a pipe outlet by simply pressing the fire protection sprinkler with a push-in connection 800 into the pipe outlet. Pressing the fire protection sprinkler with a push-in connection 800 into the pipe outlet will cause the retaining clip 835 to retract into the groove 837 to allow the fire protection sprinkler with a push-in connection 800 to be inserted into the pipe outlet. When the fire protection sprinkler with a push-in connection 800 is inserted into the pipe outlet so that the groove 837 in the fire protection sprinkler with a push-in connection 800 is adjacent to the corresponding groove in the pipe outlet, the retaining clip 835 will elastically expand into the groove in the pipe outlet, releasably retaining the fire protection sprinkler with a push-in connection 800 in the pipe outlet.

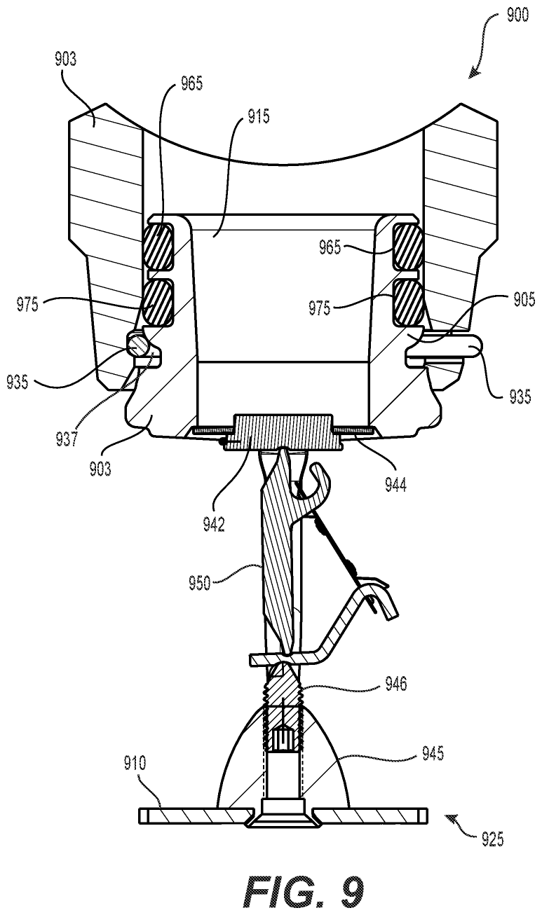

FIG. 9 is an elevational, cross-sectional view taken along line 9-9 shown in FIG. 7A of a fire protection sprinkler with a push-in connection 900 of our invention in an assembled (i.e., installed) state in pipe outlet 903. Pipe outlet 903 has a notch 937 into which the retaining clip 935 is engaged. FIG. 9 shows first gasket or O-ring seal 965 and second gasket or O-ring seal 975 to be mounted in corresponding recesses. Similarly, retaining clip 935 is mounted in recess 937. The sprinkler includes frame arms (not shown in this view) extending to base portion 945. The sprinkler also includes a frangible element 950 that is held in place on its lower end by a set screw 946 and on its upper end by a connector (not shown) that connects with stopper 942. The sprinkler also includes a deflector 925 that extends from the base portion 945. Deflector 925 includes upper surface 910. As noted above with reference to FIGS. 3 to 5, deflector 925 can be a circular disk having a number of slots of varying length and orientation arrayed around its periphery. The deflector 925 is formed of metal, such as, for example, phosphor bronze.

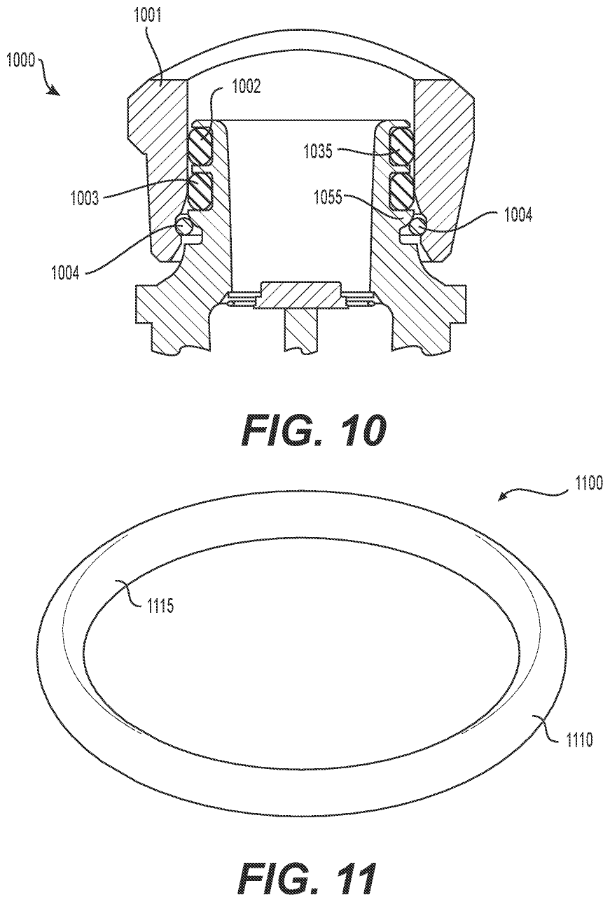

FIG. 10 is a partial, elevational, cross-sectional view taken along line 10-10 shown in FIG. 7A of a fire protection sprinkler with a push-in connection 1000 of our invention in an assembled (i.e., installed) state in pipe outlet 1003. Pipe outlet 1003 has a notch 1037 into which the retaining clip 1035 is engaged. FIG. 10 shows first gasket or O-ring seal 1065 and second gasket or O-ring seal 1075 to be mounted in corresponding recesses. Similarly, retaining clip 1035 is mounted in recess 1037. For ease of discussion, FIG. 10 does not show the sprinkler portion.

FIG. 11 shows a perspective view of an O-ring seal 1100 for use with a fire protection sprinkler with a push-in connection of our invention. FIG. 11 includes reference number 1110, showing an outer peripheral edge, and reference number 1115, showing an inner peripheral edge. As discussed in detail above, our invention uses two O-ring seals 1100 to provide redundancy and to reduce (or even to eliminate) the potential for leakage.

Generally speaking, an O-ring, also known as a packing or a toric joint, is a mechanical gasket in the shape of a torus. It is a loop of elastomer with a round cross section, designed to be seated in a groove and compressed during assembly between two or more parts, creating a seal at the interface.

The O-ring may be used in static applications or in dynamic applications, where there is relative motion between the parts and the O-ring. Static applications of O-rings may include fluid or gas sealing applications in which: (1) the O-ring is compressed resulting in zero clearance, (2) the O-ring material is a vulcanized solid such that it is impermeable to the fluid or gas, and (3) the O-ring material is resistant to degradation by the fluid or gas.

O-rings are one of the most common seals used in machine design because they are inexpensive, easy to make, reliable, and have simple mounting requirements. They have been tested to seal up to 5000 psi (35 megapascals) of pressure. The maximum recommended pressure of an O-ring seal depends on the seal hardness and gland clearance.

O-rings are available in various metric and inch standard sizes. Sizes are specified by the inside diameter and the cross-sectional diameter (thickness). In the U.S., the most common standard inch sizes are per SAE AS568C specification (e.g., AS568-214). ISO 3601-1:2012 contains the most commonly used standard sizes, both inch and metric, worldwide. The UK also has standards sizes known as British Standard (BS) sizes, typically, ranging from BS001 to BS932. Several other size specifications also exist.

Successful O-ring joint design requires a rigid mechanical mounting that applies a predictable deformation to the O-ring. This introduces a calculated mechanical stress at the O-ring contacting surfaces. As long as the pressure of the fluid being contained does not exceed the contact stress of the O-ring, leaking cannot occur. The pressure of the contained fluid transfers through the essentially incompressible O-ring material, and the contact stress rises with increasing pressure. For this reason, an O-ring can easily seal high pressure as long as it does not fail mechanically. The most common failure is extrusion through the mating parts.

The seal is designed to have a point contact between the O-ring and sealing faces. This allows a high local stress, able to contain high pressure, without exceeding the yield stress of the O-ring body. The flexible nature of O-ring materials accommodates imperfections in the mounting parts. But, it is still important to maintain good surface finish of those mating parts, especially at low temperatures where the seal rubber reaches its glass transition temperature and becomes increasingly crystalline. Surface finish is also especially important in dynamic applications. A surface finish that is too rough will abrade the surface of the O-ring, and a surface that is too smooth will not allow the seal to be adequately lubricated by a fluid film.

O-ring selection is based on chemical compatibility, application temperature, sealing pressure, lubrication requirements, durometer, size, and cost.

O-rings are typically made from the following materials:

(A) Synthetic rubbers or thermosets
Butadiene rubber (BR)
Butyl rubber (IIR)
Chlorosulfonated polyethylene (CSM)
Epichlorohydrin rubber (ECH, ECO)
Ethylene propylene diene monomer (EPDM): good resistance to hot water and steam, detergents, caustic potash solutions, sodium hydroxide solutions, silicone oils and greases, many polar solvents and many diluted acids and chemicals. Special formulations are excellent for use with glycol-based brake fluids. Unsuitable for use with mineral oil products: lubricants, oils, or fuels. Peroxide-cured compounds are suitable for higher temperatures.
Ethylene propylene rubber (EPR)
Fluoroelastomer (FKM): noted for their very high resistance to heat and a wide variety of chemicals. Other key benefits include excellent resistance to aging and ozone, very low gas permeability and the fact that the materials are self-extinguishing. Standard FKM materials have excellent resistance to mineral oils and greases, aliphatic, aromatic and chlorinated hydrocarbons, fuels, non-flammable hydraulic fluids (HFD) and many organic solvents and chemicals. Generally, not resistant to hot water, steam, polar solvents, glycol-based brake fluids and low molecular weight organic acids. In addition to the standard FKM materials, a number of specialty materials with different monomer compositions and fluorine content (65% to 71%) are available that offer improved chemical or temperature resistance and/or better low temperature performance.
Nitrile rubber (NBR, HNBR, HSN, Buna-N): a common material for O-rings because of its good mechanical properties, its resistance to lubricants and greases, and its relatively low cost. The physical and chemical resistance properties of NBR materials are determined by the acrylonitrile (ACN) content of the base polymer: low content ensures good flexibility at low temperatures, but offers limited resistance to oils and fuels. As the ACN content increases, the low temperature flexibility reduces and the resistance to oils and fuels improves. Physical and chemical resistance properties of NBR materials are also affected by the cure system of the polymer. Peroxide-cured materials have improved physical properties, chemical resistance and thermal properties, as compared to sulfur-donor-cured materials. Standard grades of NBR are typically resistant to mineral oil-based lubricants and greases, many grades of hydraulic fluids, aliphatic hydrocarbons, silicone oils and greases and water to about 80° C. NBR is generally not resistant to aromatic and chlorinated hydrocarbons, fuels with a high aromatic content, polar solvents, glycol-based brake fluids and non-flammable hydraulic fluids (HFD). NBR also has low resistance to ozone, weathering and aging. HNBR has considerable improvement of the resistance to heat, ozone and aging, and gives it good mechanical properties.
Perfluoroelastomer (FFKM)
Polyacrylate rubber (ACM)
Polychloroprene (neoprene) (CR)
Polyisoprene (IR)
Polysulfide rubber (PSR)
Polytetrafluoroethylene (PTFE)
Sanifluor (FEPM)
Silicone rubber (SiR): noted for their ability to be used over a wide temperature range and for excellent resistance to ozone, weathering and aging. Compared with most other sealing elastomers, the physical properties of silicones are poor. Generally, silicone materials are physiologically harmless so they are commonly used by the food and drug industries. Standard silicones are resistant to water (to 100° C.), aliphatic engine and transmission oils and animal and plant oils and fats. Silicones are generally not resistant to fuels, aromatic mineral oils, steam (short term to 120° C. is possible), silicone oils and greases, acids or alkalis. Fluorosilicone elastomers are far more resistant to oils and fuels. The temperature range of applications is somewhat more restricted.
Styrene-butadiene rubber (SBR); and

(B) Thermoplastics:
Thermoplastic elastomer (TPE) styrenics
Thermoplastic polyolefin (TPO) LDPE, HDPE, LLDPE, ULDPE
Thermoplastic polyurethane (TPU) polyether, polyester: Polyurethanes differ from classic elastomers in that they have much better mechanical properties. In particular they have a high resistance to abrasion, wear and extrusion, a high tensile strength and excellent tear resistance. Polyurethanes are generally resistant to aging and ozone, mineral oils and greases, silicone oils and greases, nonflammable hydraulic fluids HFA & HFB, water up to 50° C. and aliphatic hydrocarbons.
Thermoplastic etheresterelastomers (TEEEs) copolyesters
Thermoplastic polyamide (PEBA) Polyamides
Melt Processible Rubber (MPR)
Thermoplastic Vulcanizate (TPV)

(C) Chemical Compatibility
Air, 200-300° F.—Silicone
Water—EPDM

FIG. 12 is a plan view of a retaining clip 1200 for use with a fire protection sprinkler with a push-in connection of our invention. The retaining clip 1200 has an outer semi-circular shape, having an arcuate segment 1204, and ends 1210 and 1220. (We have discussed the operation of the retaining clip 1200 in detail above. Accordingly, we will not repeat that discussion here.)

The retaining clip 1200 may have various cross-sectional shapes. We prefer that the retaining clip 1200 be circular in cross section. We note, however, that retaining clip 1200 may have other cross-sectional shapes as desired, such as triangular, rectangular, pentagonal, octangular, and the like. Generally speaking, retaining clip 1200 is made of spring wire and is circular in cross section, having a diameter in the range of 0.0625 inch to 0.25 inch, and, likely, will have a diameter of about 0.12 inch. Retaining clip 1200 will have these general dimensions, even if having other cross-sectional configurations.

The five most common spring wire material options are:
Stainless Steel—Cold drawn, general-purpose wire. Features include corrosion and heat resistance.
Music Wire—Highest quality cold drawn, high carbon wire. High strength and features a good surface finish.
Hard Drawn MB—Cold drawn wire for average stress applications. Medium strength and low cost.
Oil Tempered—Wire is cold drawn, and heat treated before fabrication. Good general-purpose spring wire for torsion springs.
Brass—Generally not used as commonly due to cost. Tends to tarnish and change color over time. Features good corrosion and water resistance.
Nickel alloy. Generally speaking, the material for the retainer clip 1200 would be selected to act as a spring and have good corrosion resistance. Nickel alloy (as well as the other materials mentioned above) provides these attributes.

FIG. 13 is an elevational view of a retaining clip showing arcuate (i.e., semi-cylindrical) portion 1304 for use with a fire protection sprinkler with a push-in connection of our invention. Specifically, arcuate portion 1304 has a semi-circular shape of at least fifty percent, but not more than ninety percent of a perimeter of a circle.

While the present invention has been described with respect to what are, at present, considered to be the preferred embodiments, it is to be understood that the invention is not limited to the disclosed embodiments. To the contrary, the invention is intended to cover various modifications and equivalent arrangements included within the spirit and scope of the appended claims.

We claim:

1. A fire protection sprinkler with a push-in connection comprising:
a sprinkler body having an input orifice at an input end of the sprinkler for receiving fluid and an output orifice at an output end for outputting the fluid, the body having a push-in connection portion at the input end and an extended portion extending between the push-in connection portion and the output end, the push-in connection portion being adapted to be connected to a pipe fitting by insertion and having a plurality of recesses, a first recess having a first gasket therein, a second recess having a second gasket therein, and a third recess having a retaining clip therein;
a pair of frame arms extending from the input end and meeting at a base portion positioned in axial alignment with the output orifice, wherein the frame arms are integrally formed with the body;
a frangible element held in place on its lower end by a set screw and on its upper end by a stopper, the set screw being attached to the base portion, the frangible element being designed to fail at a predetermined temperature in order to release the stopper; and
a deflector positioned on the base portion and configured to direct the fluid output from the output orifice substantially in a direction toward the output end, upon activation of the sprinkler by failure of the frangible element at the predetermined temperature.

2. The fire protection sprinkler with a push-in connection according to claim 1, wherein the first recess with the first gasket therein, the second recess with the second gasket, and the third recess with the retaining clip therein are in a stacked arrangement, with the third recess with the retaining clip therein being nearest to the frame arms.

3. The fire protection sprinkler with a push-in connection according to claim 1, wherein the first recess with the first gasket therein, the second recess with the second gasket, and the third recess with the retaining clip therein are in a stacked arrangement, with the first recess with the first gasket therein being nearest to the input end.

4. The sprinkler with a push-in connection according to claim 1, wherein the retaining clip is a spring mechanism so that the diameter of the retaining clip is reduced when the sprinkler with the push-in connection is inserted into the pipe fitting.

5. The sprinkler with a push-in connection according to claim 3, wherein the retaining clip maintains pressure against the pipe fitting when the sprinkler is installed to the pipe fitting.

6. The sprinkler with a push-in connection according to claim 1, wherein, to provide a positive connection between the retaining clip and the pipe fitting, the pipe fitting has a circumferential groove in its inner bore so that the retaining clip is located at least partially within both the third recess in the sprinkler and the circumferential groove in the pipe fitting when the sprinkler is installed.

7. The sprinkler with a push-in connection according to claim 6, wherein the retaining clip temporarily deforms while the sprinkler is inserted into the pipe fitting, and, when the sprinkler is fully inserted, is then retained within both the third recess in the sprinkler and the circumferential groove in the pipe fitting.

8. The sprinkler with a push-in connection according to claim 1, wherein the sprinkler is removed from the pipe fitting by compressing both ends of the retaining clip so that the retaining clip is less than the diameter of the internal bore of the pipe fitting allowing the sprinkler to be readily pulled from the pipe fitting.

9. The sprinkler with a push-in connection according to claim 8, wherein the sprinkler may be removed from the pipe fitting for inspection, testing, or replacement of the sprinkler.

10. The sprinkler with a push-in connection according to claim 1, wherein the first gasket and the second gasket are each O-ring seals to provide redundancy and to reduce the potential for leakage when the sprinkler is installed in the pipe fitting.

11. The sprinkler with a push-in connection according to claim 10, wherein the O-ring seals are selected from synthetic rubbers and thermoplastics, depending on desired chemical compatibility, application temperature, sealing pressure, and lubrication requirements.

12. The sprinkler with a push-in connection according to claim 1, wherein the retaining clip has a round cross section.

13. The sprinkler with a push-in connection according to claim 12, wherein the retaining clip has a diameter in the range of 0.0625 inch to 0.25 inch.

14. The sprinkler with a push-in connection according to claim 13, wherein the retaining clip has a diameter of 0.12 inch.

15. The sprinkler with a push-in connection according to claim 1, wherein the retaining clip is selected to act as a spring and to have desired corrosion resistance.

16. The sprinkler with a push-in connection according to claim 15, wherein the retaining clip is made of spring wire selected from the group consisting of stainless steel, music wire, hard drawn, oil tempered, brass, and nickel alloy.

17. The sprinkler with a push-in connection according to claim 1, wherein the retaining clip has an outer semi-circular shape of at least fifty percent, but not more than ninety percent, of a perimeter of a circle.

18. The sprinkler with a push-in connection according to claim 1, wherein the retaining clip has one of a triangular, rectangular, pentagonal, and octagonal shape.
